(19) United States
(12) Patent Application Publication
(10) Pub. No.: US 2025/0181973 A1
(43) Pub. Date: Jun. 5, 2025

(54) TECHNIQUES FOR OPTIMIZED ROUTING OF INPUTS TO MACHINE LEARNING MODELS

(71) Applicant: NETFLIX, INC., Los Gatos, CA (US)

(72) Inventor: Kabir NAGRECHA, Pasadena, CA (US)

(21) Appl. No.: 18/882,561

(22) Filed: Sep. 11, 2024

Related U.S. Application Data
(60) Provisional application No. 63/606,339, filed on Dec. 5, 2023.

(51) Int. Cl. G06N 20/00

(52) U.S. Cl. CPC G06N 20/00

(57) ABSTRACT

One embodiment of a method for routing inputs to machine learning models includes computing one or more metric values based on an input, determining, for at least one trained machine learning models included in a plurality of trained machine learning models, a corresponding output quality degradation based on the one or more metric values, wherein the corresponding output quality degradation is relative to a most computationally expensive trained machine learning model included in the plurality of trained machine learning models, selecting a first trained machine learning model included in the plurality of trained machine learning models based on the corresponding output quality degradations, and transmitting the input to the first trained machine learning model for execution.

### CROSS-REFERENCE TO RELATED APPLICATIONS

This application claims benefit of the United States Provisional Patent Application titled “ROUTING OVER LLMS USING PROXY METRICS FOR RELATIVE QUALITY ESTIMATION,” filed Dec. 5, 2023, and having Ser. No. 63/606,339. The subject matter of this related application is hereby incorporated herein by reference.

### BACKGROUND

### Field of the Various Embodiments

Embodiments of the present disclosure relate generally to computer science, machine learning, and artificial intelligence (AI) and, more specifically, to techniques for optimized routing of inputs to machine learning models.

### DESCRIPTION OF THE RELATED ART

Machine learning can be used to discover trends, patterns, relationships, and/or other attributes related to large sets of complex, interconnected, and/or multidimensional data. To glean insights from large data sets, regression models, artificial neural networks, support vector machines, decision trees, naïve Bayes classifiers, and/or other types of machine learning models can be trained using input-output pairs in the data. In turn, the trained machine learning models can be used to guide decisions and/or perform actions related to the data or similar data.

Within machine learning, neural networks can be trained to perform a wide range of tasks with a high degree of accuracy. Neural networks are therefore becoming more widely adopted in the field of artificial intelligence. Neural networks can have a diverse range of network architectures. In more complex scenarios, the network architecture for a neural network can include many different types of layers with an intricate topology of connections among the different layers. For example, some neural networks can have ten or more layers, where each layer can include hundreds or thousands of neurons and can be coupled to one or more other layers via hundreds or thousands of individual connections. Weights and biases associated with those connections, which are also sometimes referred to as “parameters” of the neural network, control the strength of the connections and affect the activation of neurons.

One drawback of conventional machine learning models, and neural networks in particular, is that these models can be very computationally expensive to execute, both in terms of the computational resources and the time that are required to train and execute such models. In addition, training and executing conventional machine learning models oftentimes consumes a significant amount of energy. As a general matter, conventional machine learning models become more computationally expensive and require more energy to execute as the models grow in size, such as when the number of parameters within a neural network increases. However, the smaller the model size, the less reliable or accurate the outputs of the model become. Currently, there are few, if any, robust ways to automatically manage the tradeoff between the size of a machine learning model and the accuracy of a machine learning model, especially for machine learning models that are able to generate multiple types of outputs with different accuracies.

As the foregoing illustrates, what is needed in the art are more effective techniques for implementing machine learning models.

### SUMMARY

One embodiment of the present disclosure sets forth a computer-implemented method for routing inputs to machine learning models for execution. The method includes computing one or more metric values based on an input. The method also includes determining, for at least one trained machine learning models included in a plurality of trained machine learning models, a corresponding output quality degradation based on the one or more metric values, wherein the corresponding output quality degradation is relative to a most computationally expensive trained machine learning model included in the plurality of trained machine learning models. The method further includes selecting a first trained machine learning model included in the plurality of trained machine learning models based on the corresponding output quality degradations. In addition, the method includes transmitting the input to the first trained machine learning model for execution.

Other embodiments of the present disclosure include, without limitation, one or more computer-readable media including instructions for performing one or more aspects of the disclosed techniques as well as a computing device for performing one or more aspects of the disclosed techniques.

At least one technical advantage of the disclosed techniques relative to the prior art is that the disclosed techniques robustly and reliably balance the tradeoff between the size of a machine learning model and the accuracy of a machine learning model in a way that can be implemented for many, if not all, machine learning model applications. In this regard, the disclosed techniques route inputs to a first machine learning model within a set of machine learning models for execution, where the first machine learning model is the least computationally expensive machine learning model within the set of machine learning models having a predicted output quality degradation relative to the output quality of the most computationally expensive machine learning within the set of machine learning models that satisfies a desired constraint. By using the least computationally expensive machine learning model, while maintaining a desired level of output quality, the disclosed techniques can save computational resources, computational time, and energy. In addition, the predicted relative output quality degradation between the least expensive machine learning model and the most computationally expensive machine learning model within the set of machine learning models can be computed in an efficient manner using relatively simple metrics, including metrics specific to particular domains, while still being able to predict the relative output accuracy for different types of inputs that can be processed using the set of machine learning models. These technical advantages represent one or more technological improvements over prior art approaches.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram illustrating a computer system configured to implement one or more aspects of the various embodiments;

FIG. 2 is a more detailed illustration of the server of FIG. 1, according to various embodiments;

FIG. 3 is a more detailed illustration of the computing device of FIG. 1, according to various embodiments;

FIG. 4 is a more detailed illustration of the relative degradation application of FIG. 1, according to various embodiments;

FIG. 5A illustrates relative output quality degradations of exemplar machine learning models for a query length metric, according to various embodiments;

FIG. 5B illustrates relative output quality degradations of exemplar machine learning models for a reading time metric, according to various embodiments;

FIG. 5C illustrates relative output quality degradations of exemplar machine learning models for a number of named entities metric, according to various embodiments;

FIG. 6 is a more detailed illustration of the routing application of FIG. 1, according to various embodiments;

FIG. 7 illustrates a flow diagram of method steps for determining the relative output quality degradations of the different machine learning models included in a set of machine learning models, according to various embodiments; and

FIG. 8 illustrates a flow diagram of method steps for routing an input for execution by a given machine learning model included in a set of machine learning models based on relative output quality degradation, according to various embodiments.

### DETAILED DESCRIPTION

As described, conventional machine learning models, and neural networks in particular, can be very computationally expensive to execute, both in terms of the computational resources and the time that are required to execute such models. Execution of conventional machine learning models can also consume a significant amount of energy. As a general matter, conventional machine learning models become more computationally expensive and require more energy to execute as the models grow in size, such as when the number of parameters within a neural network increases. However, the smaller the model size, the less reliable or accurate the outputs of the model become. Currently, there are few, if any, robust ways to automatically manage the tradeoff between the size of a machine learning model and the accuracy of a machine learning model, especially for machine learning models that are able to process multiple types of inputs to generate multiple types of outputs with different accuracies.

The disclosed techniques route inputs over machine learning models for processing. In some embodiments, a relative degradation application receives example inputs and computes one or more metric values for the example inputs. The relative degradation application determines, for each of the example inputs, a relative degradation between the quality of the output of each machine learning model in a set of machine learning models and the output of a most computationally expensive machine learning model in the set of machine learning models. Associations between the metric value(s) and the relative output quality degradations of the machine learning models are stored. Given an input, a routing application computes the same metric value(s) for the input and selects, based on the associations between metric value(s) and relative output quality degradations of the machine learning models, a least computationally expensive machine learning model from the set of machine learning models that is associated with a relative output quality degradation that satisfies a predefined constraint. Then, the application processes the input using the selected machine learning model to generate an output.

At least one technical advantage of the disclosed techniques relative to the prior art is that the disclosed techniques robustly and reliably balance the tradeoff between the size of a machine learning model and the accuracy of a machine learning model in a way that can be implemented for many, if not all, machine learning model applications. In this regard, the disclosed techniques route inputs to a first machine learning model within a set of machine learning models for execution, where the first machine learning model is the least computationally expensive machine learning model within the set of machine learning models having a predicted output quality degradation relative to the output quality of the most computationally expensive machine learning within the set of machine learning models that satisfies a desired constraint. By using the least computationally expensive machine learning model, while maintaining a desired level of output quality, the disclosed techniques can save computational resources, computational time, and energy. In addition, the predicted relative output quality degradation between the least expensive machine learning model and the most computationally expensive machine learning model within the set of machine learning models can be computed in an efficient manner using relatively simple metrics, including metrics specific to particular domains, while still being able to predict the relative output accuracy for different types of inputs that can be processed using the set of machine learning models.

### System Overview

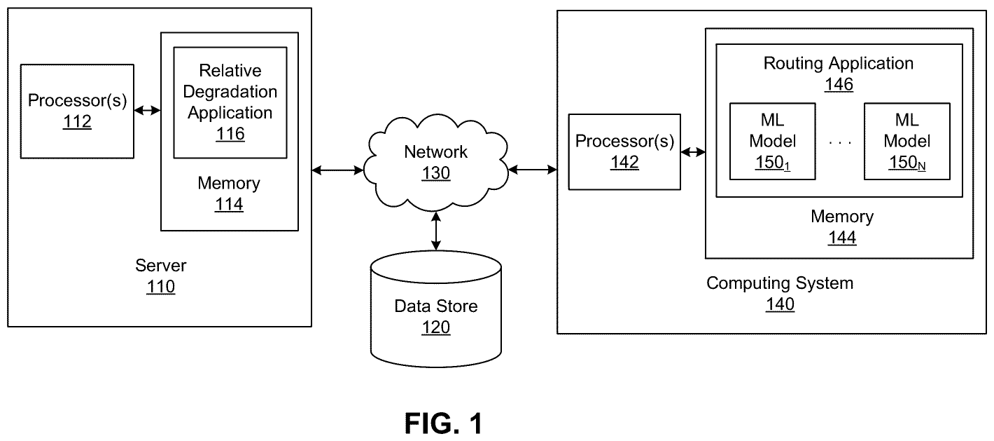

FIG. 1 illustrates a block diagram of a computer-based system 100 configured to implement one or more aspects of various embodiments. As shown, the system 100 includes a server 110, a data store 120, and a computing system 140 in communication over a network 130, which can be a wide area network (WAN) such as the Internet, a local area network (LAN), a cellular network, and/or any other suitable network.

As shown, a relative degradation application 116 executes on one or more processors 112 of the server 110 and is stored in a system memory 114 of the server 110. The processor(s) 112 receive user input from input devices, such as a keyboard or a mouse. In operation, the processor(s) 112 may include one or more primary processors of the server 110, controlling and coordinating operations of other system components. In particular, the processor(s) 112 can issue commands that control the operation of one or more graphics processing units (GPUs) (not shown) and/or other parallel processing circuitry (e.g., parallel processing units, deep learning accelerators, etc.) that incorporates circuitry optimized for graphics and video processing, including, for example, video output circuitry. The GPU(s) can deliver pixels to a display device that can be any conventional cathode ray tube, liquid crystal display, light-emitting diode display, and/or the like.

The system memory 114 of the server 110 stores content, such as software applications and data, for use by the processor(s) 112 and the GPU(s) and/or other processing units. The system memory 114 can be any type of memory capable of storing data and software applications, such as a random-access memory (RAM), a read-only memory (ROM), an erasable programmable read-only memory (EPROM or Flash ROM), or any suitable combination of the foregoing. In some embodiments, a storage (not shown) can supplement or replace the system memory 114. The storage can include any number and type of external memories that are accessible to the processor 112 and/or the GPU. For example, and without limitation, the storage can include a Secure Digital Card, an external Flash memory, a portable compact disc read-only memory (CD-ROM), an optical storage device, a magnetic storage device, and/or any suitable combination of the foregoing.

The server 110 shown herein is for illustrative purposes only, and variations and modifications are possible without departing from the scope of the present disclosure. For example, the number of processors 112, the number of GPUs and/or other processing unit types, the number of system memories 114, and/or the number of applications included in the system memory 114 can be modified as desired. Further, the connection topology between the various units in FIG. 1 can be modified as desired. In some embodiments, any combination of the processor(s) 112, the system memory 114, and/or GPU(s) can be included in and/or replaced with any type of virtual computing system, distributed computing system, and/or cloud computing environment, such as a public, private, or a hybrid cloud system.

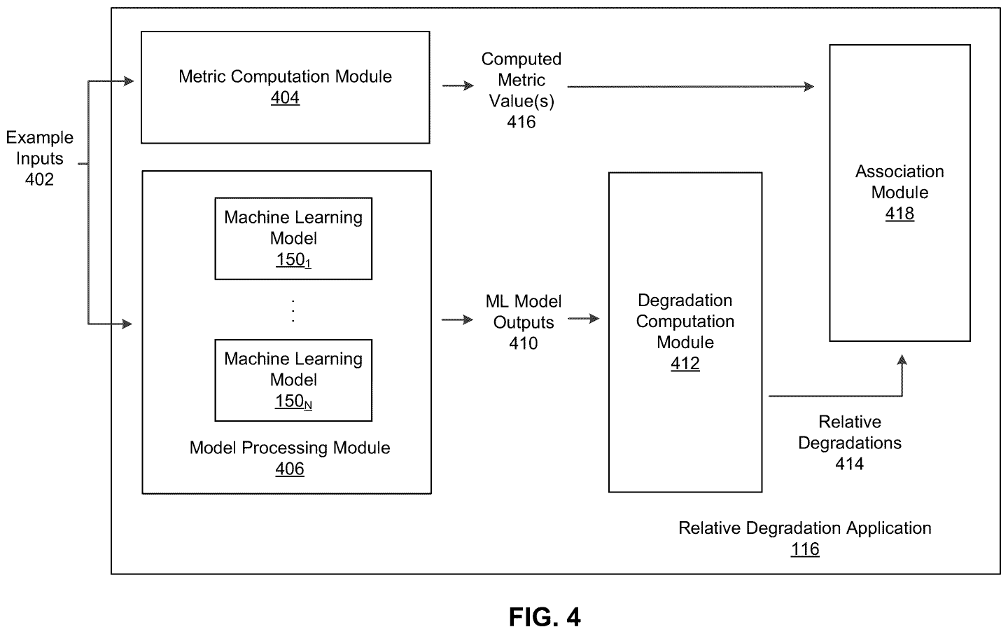

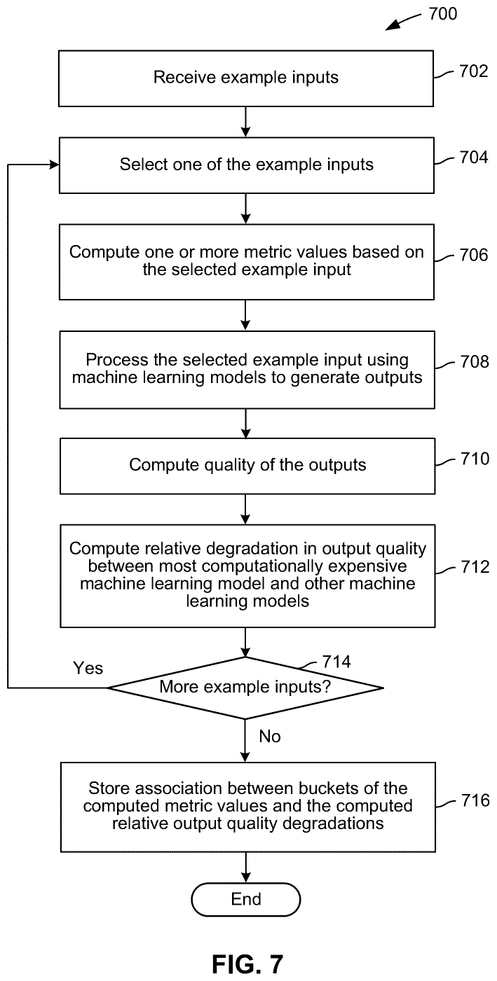

In some embodiments, the relative degradation application 116 is configured to compute metrics associated with example inputs and the relative quality degradation of output of each machine learning model in a set of machine learning models 150_{1-N} (referred to herein collectively as machine learning models 150 and individually as a machine learning model) to a most computationally expensive machine learning model 150 in the set of machine learning models 150. Techniques that the relative degradation application 116 can employ to determine relative output quality degradations are discussed in greater detail below in conjunction with FIGS. 4 and 7. Associations between the values of metrics that are computed for the example inputs and relative output quality degradations of the machine learning models 150 for those example inputs can be stored (e.g., in the data store 120 or elsewhere) and thereafter used to route inputs to the machine learning models 150. In some embodiments, the data store 120 can include any storage device or devices, such as fixed disc drive(s), flash drive(s), optical storage, network attached storage (NAS), and/or a storage area-network (SAN). Although shown as accessible over the network 130, in at least one embodiment the server 110 can include the data store 120.

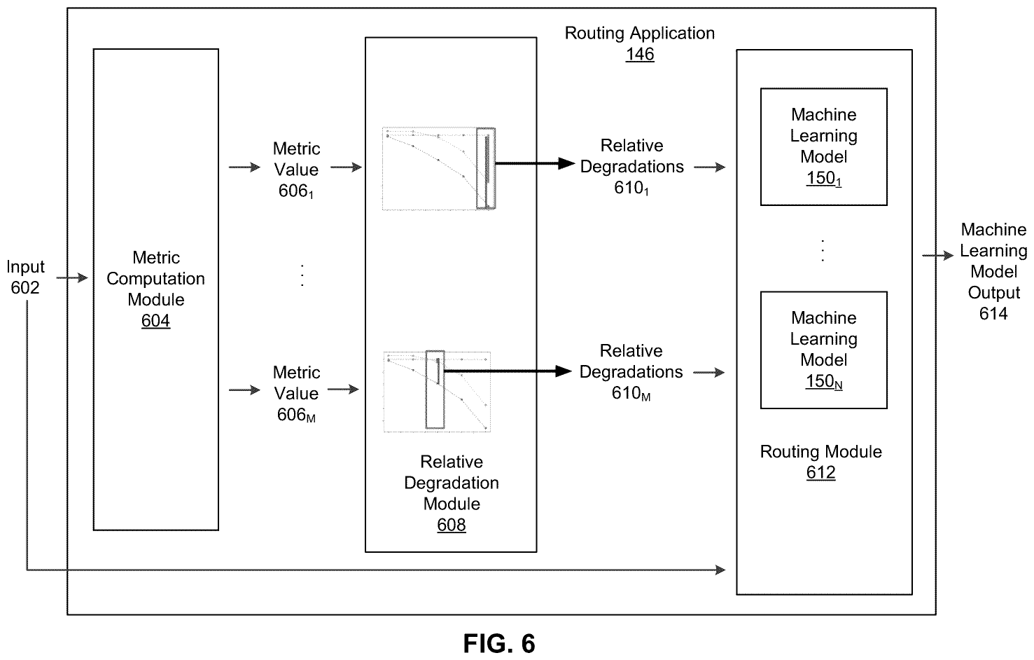

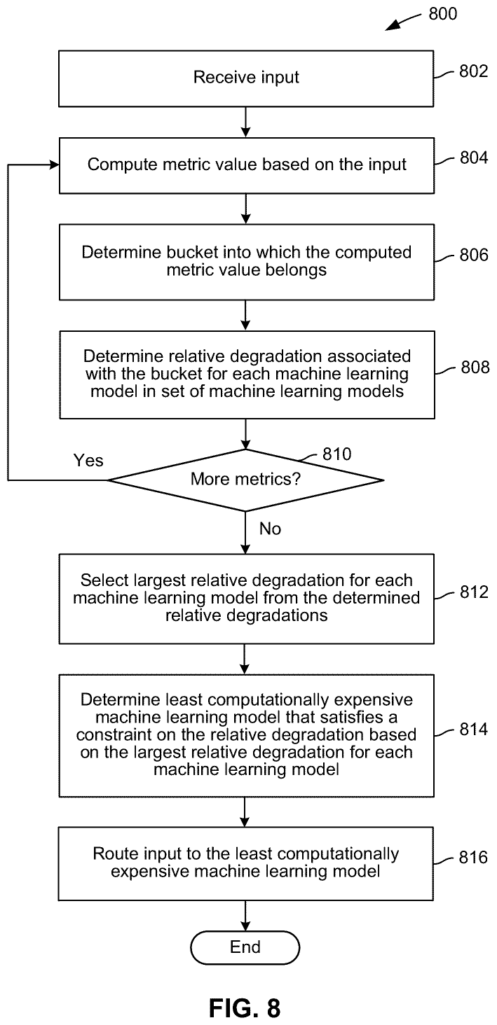

As shown, a routing application 146 is stored in a system memory 144, and executes on a processor 142, of the computing system 140. The routing application 146 can be any technically feasible application that routes inputs, such as user inputs, for processing by the machine learning models 150. Techniques that the routing application 146 can use to route inputs based on stored associations between metric values and relative output quality degradations of the machine learning models 150 are discussed in greater detail below in conjunction with FIGS. 6 and 8.

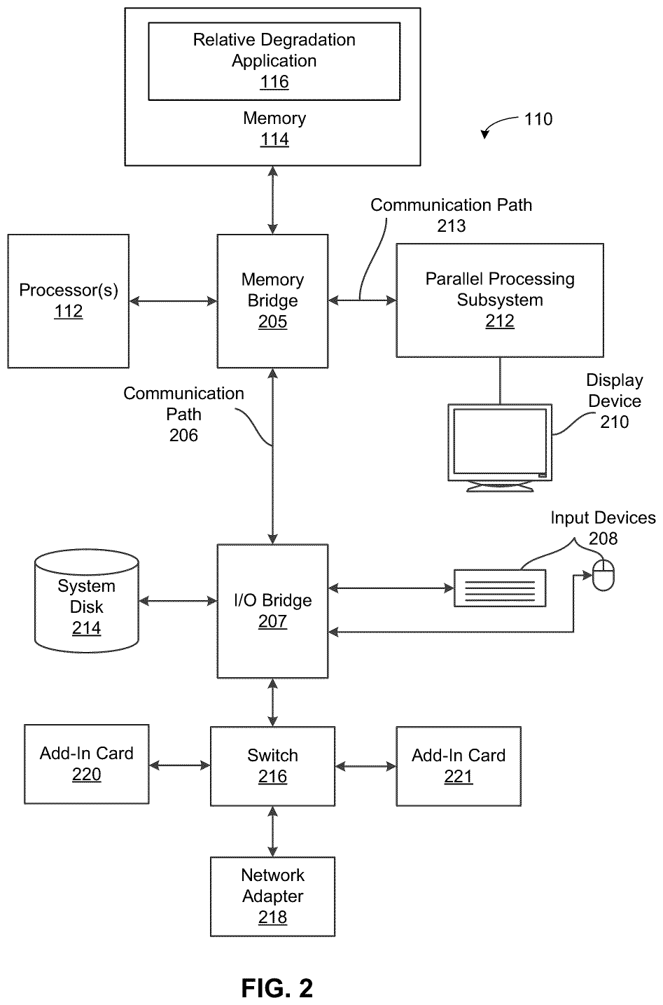

FIG. 2 is a more detailed illustration of the server 110 of FIG. 1, according to various embodiments. In some embodiments, the server 110 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the server 110 is a server machine operating in a data center or a cloud computing environment that provides scalable computing resources as a service over a network.

In some embodiments, the server 110 includes, without limitation, the processor(s) 112 and the memory (ies) 114 coupled to a parallel processing subsystem 212 via a memory bridge 205 and a communication path 206. Memory bridge 205 is further coupled to an I/O (input/output) bridge 207 via a communication path 206, and I/O bridge 207 is, in turn, coupled to a switch 216.

In some embodiments, the I/O bridge 207 is configured to receive user input information from optional input devices 208, such as a keyboard, mouse, touch screen, sensor data analysis (e.g., evaluating gestures, speech, or other information about one or more uses in a field of view or sensory field of one or more sensors), and/or the like, and forward the input information to the processor(s) 112 for processing. In some embodiments, the server 110 can be a server machine in a cloud computing environment. In such embodiments, the server 110 cannot include input devices 208, but can receive equivalent input information by receiving commands (e.g., responsive to one or more inputs from a remote computing device) in the form of messages transmitted over a network and received via a network adapter 218. In some embodiments, the switch 216 is configured to provide connections between I/O bridge 207 and other components of the server 110, such as a network adapter 218 and various add in cards 220 and 221.

In some embodiments, the I/O bridge 207 is coupled to a system disk 214 that may be configured to store content and applications and data for use by the processor(s) 112 and the parallel processing subsystem 212. In some embodiments, the system disk 214 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 207 as well.

In some embodiments, the memory bridge 205 may be a Northbridge chip, and the I/O bridge 207 may be a Southbridge chip. In addition, the communication paths 206 and 213, as well as other communication paths within the server 110, can be implemented using any technically suitable protocols, including, without limitation, AGP (Accelerated Graphics Port), HyperTransport, or any other bus or point to point communication protocol known in the art.

In some embodiments, the parallel processing subsystem 212 comprises a graphics subsystem that delivers pixels to an optional display device 210 that may be any conventional cathode ray tube, liquid crystal display, light-emitting diode display, and/or the like. In such embodiments, the parallel processing subsystem 212 may incorporate circuitry optimized for graphics and video processing, including, for example, video output circuitry. Such circuitry may be incorporated across one or more parallel processing units (PPUs), also referred to herein as parallel processors, included within the parallel processing subsystem 212.

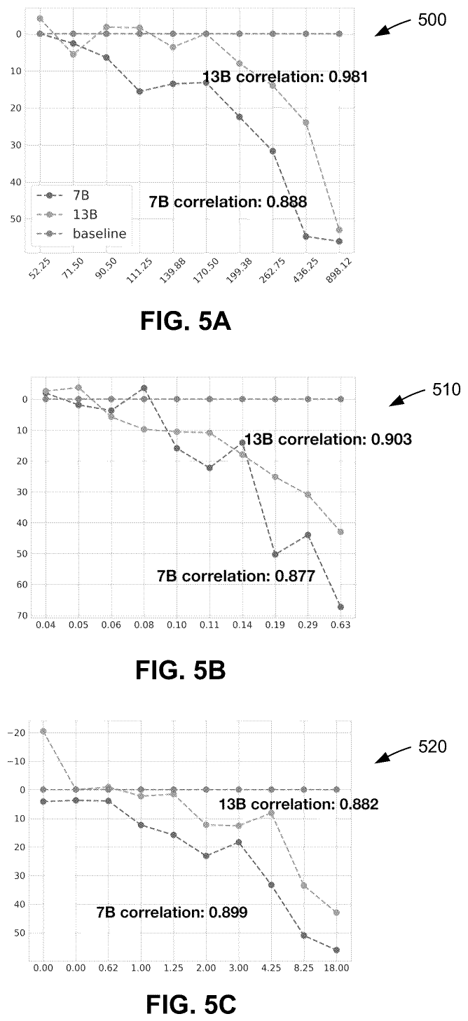

In some embodiments, the parallel processing subsystem 212 incorporates circuitry optimized (e.g., that undergoes optimization) for general purpose and/or compute processing. Again, such circuitry may be incorporated across one or more PPUs included within the parallel processing subsystem 212 that are configured to perform such general purpose and/or compute operations. In yet other embodiments, the one or more PPUs included within the parallel processing subsystem 212 may be configured to perform graphics processing, general purpose processing, and/or compute processing operations. The system memory 114 includes at least one device driver configured to manage the processing operations of the one or more PPUs within the parallel processing subsystem 212. In addition, the system memory 114 includes the relative degradation application 116, which is discussed in greater detail below in conjunction with FIGS. 5 and 7. Although described herein primarily with respect to the relative degradation application 116, techniques disclosed herein can also be implemented, either entirely or in part, in other software and/or hardware, such as in the parallel processing subsystem 212.

In some embodiments, the parallel processing subsystem 212 can be integrated with one or more of the other elements of FIG. 2 to form a single system. For example, the parallel processing subsystem 212 can be integrated with the processor(s) 112 and other connection circuitry on a single chip to form a system on a chip (SoC).

In some embodiments, the processor(s) 112 includes the primary processor of the server 110, controlling and coordinating operations of other system components. In some embodiments, the processor(s) 112 issues commands that control the operation of PPUs. In some embodiments, the communication path 213 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 112, and the number of parallel processing subsystems 212, can be modified as desired. For example, in some embodiments, the system memory 114 could be connected to the processor(s) 112 directly rather than through the memory bridge 205, and other devices can communicate with the system memory 114 via the memory bridge 205 and the processor(s) 112. In other embodiments, the parallel processing subsystem 212 can be connected to the I/O bridge 207 or directly to the processor(s) 112, rather than to the memory bridge 205. In still other embodiments, the I/O bridge 207 and the memory bridge 205 can be integrated into a single chip instead of existing as one or more discrete devices. In certain embodiments, one or more components shown in FIG. 2 may not be present. For example, the switch 216 could be eliminated, and the network adapter 218 and add in cards 220, 221 would connect directly to the I/O bridge 207. Lastly, in certain embodiments, one or more components shown in FIG. 2 may be implemented as virtualized resources in a virtual computing environment, such as a cloud computing environment. In particular, the parallel processing subsystem 212 may be implemented as a virtualized parallel processing subsystem in some embodiments. For example, the parallel processing subsystem 212 may be implemented as a virtual graphics processing unit(s) (vGPU(s)) that renders graphics on a virtual machine(s) (VM(s)) executing on a server machine(s) whose GPU(s) and other physical resources are shared across one or more VMs.

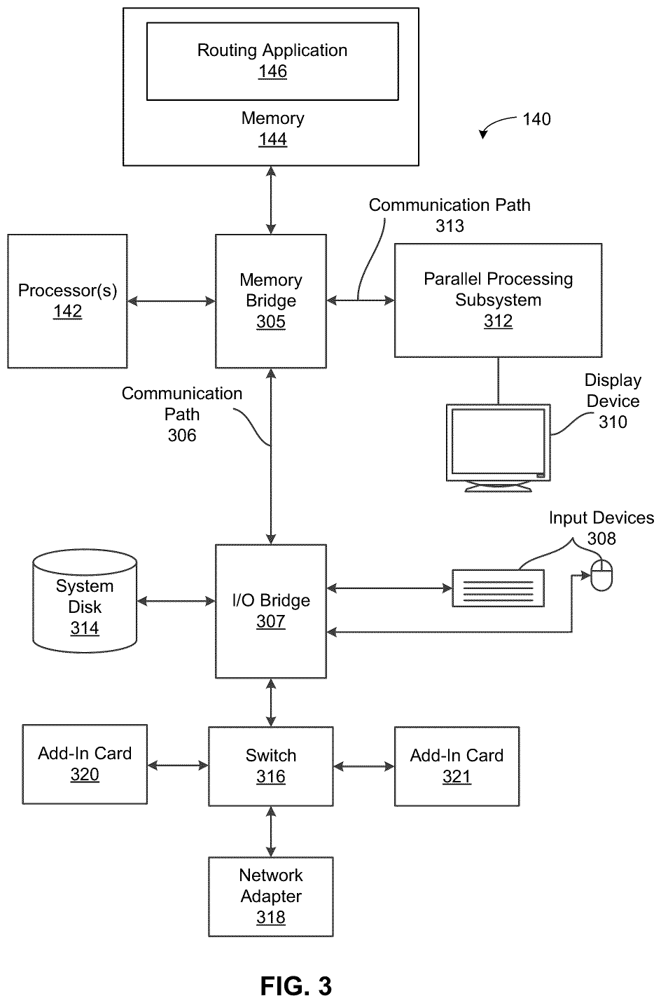

FIG. 3 is a more detailed illustration of the computing system 140 of FIG. 1, according to various embodiments. In some embodiments, the computing system 140 can include any type of computing system, including, without limitation, a server machine, a server platform, a desktop machine, a laptop machine, a hand-held/mobile device, a digital kiosk, an in-vehicle infotainment system, and/or a wearable device. In some embodiments, the computing system 140 is a server machine operating in a data center or a cloud computing environment that provides scalable computing resources as a service over a network.

In some embodiments, the computing system 140 includes, without limitation, the processor(s) 142 and the memory (ies) 144 coupled to a parallel processing subsystem 312 via a memory bridge 305 and a communication path 306. Memory bridge 305 is further coupled to an I/O (input/output) bridge 307 via a communication path 306, and I/O bridge 307 is, in turn, coupled to a switch 316.

In some embodiments, the I/O bridge 307 is configured to receive user input information from optional input devices 308, such as a keyboard, mouse, touch screen, sensor data analysis (e.g., evaluating gestures, speech, or other information about one or more uses in a field of view or sensory field of one or more sensors), and/or the like, and forward the input information to the processor(s) 142 for processing. In some embodiments, the computing system 140 can be a server machine in a cloud computing environment. In such embodiments, the computing system 140 cannot include the input devices 308, but can receive equivalent input information by receiving commands (e.g., responsive to one or more inputs from a remote computing device) in the form of messages transmitted over a network and received via a network adapter 318. In some embodiments, the switch 316 is configured to provide connections between I/O bridge 307 and other components of the computing system 140, such as a network adapter 318 and various add in cards 320 and 321.

In some embodiments, the I/O bridge 307 is coupled to a system disk 314 that may be configured to store content and applications and data for use by the processor(s) 312 and the parallel processing subsystem 312. In some embodiments, the system disk 314 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high-definition DVD), or other magnetic, optical, or solid state storage devices. In some embodiments, other components, such as universal serial bus or other port connections, compact disc drives, digital versatile disc drives, film recording devices, and the like, may be connected to the I/O bridge 307 as well.

In some embodiments, the memory bridge 305 may be a Northbridge chip, and the I/O bridge 307 may be a Southbridge chip. In addition, the communication paths 306 and 313, as well as other communication paths within the computing system 140, can be implemented using any technically suitable protocols, including, without limitation, AGP (Accelerated Graphics Port), HyperTransport, or any other bus or point to point communication protocol known in the art.

In some embodiments, the parallel processing subsystem 312 comprises a graphics subsystem that delivers pixels to an optional display device 310 that may be any conventional cathode ray tube, liquid crystal display, light-emitting diode display, and/or the like. In such embodiments, the parallel processing subsystem 312 may incorporate circuitry optimized for graphics and video processing, including, for example, video output circuitry. Such circuitry may be incorporated across one or more parallel processing units (PPUs), also referred to herein as parallel processors, included within the parallel processing subsystem 312.

In some embodiments, the parallel processing subsystem 312 incorporates circuitry optimized (e.g., that undergoes optimization) for general purpose and/or compute processing. Again, such circuitry may be incorporated across one or more PPUs included within the parallel processing subsystem 312 that are configured to perform such general purpose and/or compute operations. In yet other embodiments, the one or more PPUs included within the parallel processing subsystem 312 may be configured to perform graphics processing, general purpose processing, and/or compute processing operations. The system memory 144 includes at least one device driver configured to manage the processing operations of the one or more PPUs within the parallel processing subsystem 312. In addition, the system memory 144 includes the AV routing application 146, discussed in greater detail in conjunction with FIGS. 5-6 and 8. Although described herein primarily with respect to the AV routing application 146, techniques disclosed herein can also be implemented, either entirely or in part, in other software and/or hardware, such as in the parallel processing subsystem 312.

In some embodiments, the parallel processing subsystem 312 can be integrated with one or more of the other elements of FIG. 3 to form a single system. For example, the parallel processing subsystem 312 can be integrated with the processor(s) 142 and other connection circuitry on a single chip to form a system on a chip (SoC).

In some embodiments, the processor(s) 142 includes the primary processor of the computing system 140, controlling and coordinating operations of other system components. In some embodiments, the processor(s) 142 issues commands that control the operation of PPUs. In some embodiments, the communication path 313 is a PCI Express link, in which dedicated lanes are allocated to each PPU. Other communication paths may also be used. The PPU advantageously implements a highly parallel processing architecture, and the PPU may be provided with any amount of local parallel processing memory (PP memory).

It will be appreciated that the system shown herein is illustrative and that variations and modifications are possible. The connection topology, including the number and arrangement of bridges, the number of processor(s) 312, and the number of parallel processing subsystems 312, can be modified as desired. For example, in some embodiments, the system memory 144 could be connected to the processor(s) 142 directly rather than through the memory bridge 305, and other devices can communicate with system memory 144 via the memory bridge 305 and the processor(s) 142. In other embodiments, the parallel processing subsystem 312 can be connected to the I/O bridge 307 or directly to the processor(s) 142, rather than to the memory bridge 305. In still other embodiments, I/O bridge 307 and the memory bridge 305 can be integrated into a single chip instead of existing as one or more discrete devices. In certain embodiments, one or more components shown in FIG. 3 may not be present. For example, the switch 316 could be eliminated, and the network adapter 318 and add the in cards 320, 321 would connect directly to the I/O bridge 307. Lastly, in certain embodiments, one or more components shown in FIG. 3 may be implemented as virtualized resources in a virtual computing environment, such as a cloud computing environment. In particular, the parallel processing subsystem 312 may be implemented as a virtualized parallel processing subsystem in some embodiments. For example, the parallel processing subsystem 312 may be implemented as a virtual graphics processing unit(s) (vGPU(s)) that renders graphics on a virtual machine(s) (VM(s)) executing on a server machine(s) whose GPU(s) and other physical resources are shared across one or more VMs.

### Optimized Routing of Inputs to Machine Learning Models

FIG. 4 is a more detailed illustration of the relative degradation application 116 of FIG. 1, according to various embodiments. As shown, the relative degradation application 116 includes a metric computation module 404, a model processing module 406, a degradation computation module 412, and an association module 418. In operation, the relative degradation application 116 (1) receives example inputs 402; (2) computes one or more metric values 416 for the example inputs 402; (3) determines, for each of the example inputs 402, an quality degradation of an output of each machine learning models 150 relative to the output of a most computationally expensive one of the machine learning models 150; and (4) stores associations between the metric value(s) and the relative output quality degradations of the machine learning models 150.

The metric computation module 404 computes metric value(s) 416 for each of the example inputs 402. Any technically feasible metric(s) can be used in some embodiments. In some embodiments, the metric(s) can include domain-specific complexity measures. In some embodiments, the metric(s) can include lexical analysis techniques. For example, one of the metric(s) could be a length measure of an example input. In such cases, the length metric can be computed as a character count of the example input and can serve as a simple measure of query complexity. As another example, one of the metric(s) could be a number of nouns in an example input. In such cases, the number of nouns can be computed by counting the named entities, such as references to persons or places that can imply complex logical reasoning tasks or queries that draw on general knowledge and, therefore, inform the understanding of input complexity. As a further example, one of the metric(s) could be a reading time duration associated with an example input. In such cases, the reading time can be computed using a known reading time formula and can serve as a measure of lexical complexity. As yet another example, for an example input that includes a math problem, one of the metric(s) could be a symbol count.

The model processing module 406 processes the example inputs 402 using the machine learning models 150 to generate outputs 410. In some embodiments, any technically feasible trained machine learning models, such as trained large language models (LLMs) or other artificial neural networks that include different numbers of parameters, can be used as the machine learning models 150. In such cases, processing the example inputs 402 using the machine learning models 150 can include inputting the example inputs 402 into the machine learning models 150 that generate corresponding outputs 410.

The degradation computation module 412 computes, for each example input 402, a degradation in the quality of the output of each machine learning model 150 relative to an output of a most computationally expensive machine learning model 150, shown as relative degradations 414 for the machine learning outputs 410 relative to outputs generated by the most computationally expensive machine learning model 150. In some embodiments, the degradation computation module 412 first computes a quality of each of the outputs generated by the machine learning models 150. Any technically feasible quality metric, including domain-specific quality metrics, can be used in some embodiments to compute the quality of each output. For example, in some embodiments, the quality metric can be a score generated by a chatbot that is asked to assess the quality of an output. As another example, in some embodiments, the quality metric can be a measure of accuracy of an output. Then, the degradation computation module 412 computes a relative output quality degradation in quality between a most computationally expensive of the machine learning models 150 and each of the other machine learning models 150. Returning to the example of scores generated by a chatbot, the relative output quality degradation can be a chatbot-assessed loss that is the difference between the score for an output of the most computationally expensive machine learning model 150 and the score for the output of another machine learning model 150. The output quality degradation can be represented in any technically feasible manner, such as using a value between 0% and 100%, with 0% being no quality degradation and 100% being complete quality degradation. It should be noted that use of relative output quality degradation of each machine learning model 150 compared to the most computationally expensive machine learning model 150, rather than the absolute quality of outputs of each machine learning model 150, can result in simpler, more computationally efficient, more accurate, and/or less domain specific predictions because of the difficulty of developing accurate metrics for predicting the absolute quality of outputs of machine learning models, especially machine learning models that are able to generate multiple types of outputs with different accuracies, such as LLMs that can generate code, parse natural language text, etc. Experience has shown that relatively simple domain-specific metrics, such as length of an input, number of nouns in an input, reading time duration associated with an input, and symbol count in an input, described above, can be used to predict the relative output quality of machine learning models regardless of the type of output being generated, even if the output is in a different domain.

The association module 418 stores an association between buckets of metric values computed by the metric computation module 404 and relative output quality degradations computed by the degradation computation module 412. For example, in some embodiments, the buckets can group metric values by quantiles (e.g., deciles), and each quantile bucket for a given metric can be associated with a relative output quality degradation that is an average of the relative output quality degradations computed for example inputs 402 whose computed metric values belong to the quantile bucket. The stored association between buckets of metric values and relative output quality degradations can then be used in any technically feasible manner, such as by the routing application 146 executing in the computing device 140 to route inputs to the machine learning models 150, or by an application executing in the server 110 itself.

Although described herein primarily with respect to associating buckets of metric values with relative output quality degradations, in some embodiments, metric values can be associated with relative output quality degradations of machine learning models in any technically feasible manner. For example, in some embodiments, the association module 418 can fit a function to a curve formed by the metric values on one axis and the relative output quality degradations of a machine learning model on another axis. In such cases, the fitted function can be stored as the association between metric values and relative output quality degradations for the machine learning model.

More formally, for a given query q (or other input), the goal is to select and apply the model m with the highest inference performance that meets some user-defined quality-degradation threshold ϵ on a task metric μ. This goal can be expressed as:

$${m}_{opt} ( ϵ ) = {arg max}_{m s . t . μ ( m ( q ) ) meets ϵ} P ( m , q ) \qquad ( 1 )$$

where P refers to inference performance. The key challenge in the optimization problem of equation (1) is assessing the constraint −μ(m (q)) meets E. Computing u in the online setting is generally infeasible, since doing so can require access to a ground-truth label or an expensive verification process (e.g., for code generation by an LLM). Further, training some verifier/scorer τ as a proxy for μ, then to transform the optimization problem as

$${m}_{opt} ( ϵ ) = {arg max}_{m s . t . τ ( m ( q ) ) > ϵ} P ( m , q ) \qquad ( 2 )$$

is a non-trivial task. The approach of the relative degradation application 116 is instead to substitute the constraint to no longer rely on the relationship τ(m (q))≈μ(m (q)) or even a predictor for u. Doing so avoids computing m (q) and sidesteps challenges faced in applications with more complex and nuanced μ metrics (e.g., code generation by an LLM) where the metric is difficult to predict directly. More specifically, the relative degradation application 116 exploits and re-frames the semantics of ϵ in the objective function. Suppose a candidate set of machine learning models (e.g., machine learning models 150) exists. If a baseline machine learning model that is most computationally expensive is selected from the candidate set m′, then the constraint can be defined as follows:

$${m}_{opt} ( {ϵ}^{′} ) = {arg max}_{m s . t . \frac{μ ( m ( q ) )}{μ ( {m}^{′} ( q ) )} > ϵ} TP ( m , q ) \qquad ( 3 )$$

where ϵ′ is a relative degradation measure between the machine learning models in the set of machine learning models rather than an absolute quality threshold. While μ might be defined in a way that makes u difficult to approximate, such as a human-(or LLM-) evaluated quality score, a set of unit tests for code generation-measuring relative quality degradation only requires predicting the relationship between two machine learning models on the given task. In other words—while μ(m (q)) and μ(m′ (q)) are hard to predict,

$$\frac{μ ( m ( q ) )}{μ ( {m}^{′} ( q ) )}$$

can be informed by the relationship between m and m′.

The relative degradation application 116 uses an approximation function Θ for

$$\frac{μ ( m ( q ) )}{μ ( {m}^{′} ( q ) )} .$$

Deriving a theoretical solution to

$$\frac{μ ( m ( q ) )}{μ ( {m}^{′} ( q ) )}$$

is non-trivial. Instead, the relative degradation application 116 empirically evaluates candidate metrics c such that c (q)˜

$$\frac{μ ( m ( q ) )}{μ ( {m}^{′} ( q ) )} .$$

These metrics, such as the input length, number of nouns, reading time, and symbol count, described above, can be straightforward yet still serve as useful approximations. Functions c such that

$$c ( q ) ∼ \frac{μ ( m ( q ) )}{μ ( {m}^{′} ( q ) )} ,$$

provide a basis for the approximation function Θ. More specifically, each metric c (q) can be used to create the approximation function Θ(m, q) as follow. Given a q, the metric c (q) can be computed and mapped into a quantile on a curve correlating c (q) with

$$1 - \frac{μ ( m ( q ) )}{μ ( {m}^{′} ( q ) )} .$$

### Then, the

$$\frac{μ ( m ( q ) )}{μ ( {m}^{′} ( q ) )}$$

value associated with the upper-bound of the quantile can be taken to provide an upper-bound estimate of the relative output quality degradation.

FIG. 5A illustrates relative output quality degradations of exemplar machine learning models for a query length metric, according to various embodiments. As shown, a graph 500 of query length (x-axis) versus percentage average quality degradation (y-axis) indicates the percentage average quality degradation of the outputs of three different large language models (LLMs) for queries of different lengths that are input into the three LLMs. The three LLMs include different numbers of parameters, with a most computationally expensive LLM that includes a largest number of parameters being used as the baseline for comparison. In the examples of FIGS. 5A-5C, the baseline LLM that is most computationally expensive includes 70 billion parameters, a second most computationally expensive LLM includes 13 billion parameters, and a least computationally expensive LLM includes 7 billion parameters. The queries are assigned to quantile buckets based on the length of the queries. In addition, a Pearson correlation coefficient has been computed between the query length metric and the quality degradation to show the correlation between the metric and the degradation, and the y-axes are inverted to make the curves easier to understand visually. Experience has shown that the metrics of input length, reading time, and number of nouns are strongly correlated with output quality degradation relative to a baseline machine learning model.

FIG. 5B illustrates relative output quality degradations of exemplar machine learning models for a reading time metric, according to various embodiments. As shown, a graph 510 of reading time duration in minutes (x-axis) versus percentage average quality degradation (y-axis) indicates the percentage average quality degradation of the outputs of three different large language models (LLMs) for queries associated with different reading time durations that are input into the three LLMs. The graph 510 is similar to the graph 500, described above in conjunction with FIG. 5A, and shows the relative output quality degradation for the same three LLMs, except the metric used is reading time duration rather than query length.

FIG. 5C illustrates relative output quality degradations of exemplar machine learning models for a number of named entities metric, according to various embodiments. As shown, a graph 520 of number of named entities (x-axis) versus percentage average quality degradation (y-axis) indicates the percentage average quality degradation of the outputs of three different large language models (LLMs) for queries having different numbers of named entities that are input into the three LLMs. In some embodiments, the number of named entities can be obtained by counting the number of nouns in a query. The graph 520 is similar to the graph 500, described above in conjunction with FIG. 5A, and shows the relative output quality degradation for the same three LLMs, except the metric used is the number of named entities rather than query length.

FIG. 6 is a more detailed illustration of the routing application 146 of FIG. 1, according to various embodiments. As shown, the routing application 146 includes a metric computation module 604, a relative degradation module 608, and a routing module 612. In operation, the routing application 146 (1) receives an input 602, (2) selects one of the machine learning models 150 that is least computationally expensive and associated with a relative output quality degradation with respect to a most computationally expensive machine learning model 150 that satisfies a constraint on the relative output quality degradation, and (3) processes the input 602 using the selected machine learning model 150. Any suitable input 602, such as user input entered via a user interface (UI), can be received in some embodiments.

The metric computation module 604 computes values 6061 to 606N of one or more metrics (referred to herein collectively as metric values 606 and individually as a metric value 606) based on the input 602. Any technically feasible metrics can be used in some embodiments. In some embodiments, the metric computation module 604 can use the same metrics that are computed by the metric computation module 404 of the relative degradation application 116, described above in conjunction with FIG. 4. In some embodiments, the metrics can include domain-specific complexity measures. In some embodiments, the metric(s) can include lexical analysis techniques. For example, in some embodiments, the metrics can include a length of the input 602, a number of nouns in the input 602, a reading time duration associated with the input 602, a symbol count in the input 602, and/or the like.

The relative degradation module 608 determines a predicted relative quality degradation of the output generated by each of the machine learning models 150 for the input 602, shown as relative degradations 6101 to 610N (referred to herein collectively as relative degradations 610 and individually as a relative degradation 610). In some embodiments, the relative degradation module 608 first determines a bucket, such as a quantile bucket, that the computed metric belongs to. Then, the relative degradation module 608 determines a relative output quality degradation associated with the bucket for each of the machine learning models 150. The relative output quality degradation associated with the bucket for each machine learning model 150 can be pre-computed by the relative degradation application 116, as described above in conjunction with FIG. 4.

The routing module 612 routes the input 602 for processing by a least computationally expensive machine learning model that satisfies a constraint on the relative output quality degradation. Such processing generates a machine learning model output 614. In some embodiments, the routing module 612 selects, for each of the machine learning models 150, a largest relative output quality degradation from the relative output quality degradations determined by the relative degradation module 608. Then, the routing module 612 determines a least computationally expensive machine learning model 150 whose largest relative output quality degradation satisfies a constraint on the relative output quality degradation. How computationally expensive each machine learning model 150 is to execute can be known. For example, in some embodiments, machine learning models 150 that include more parameters can be considered to be more computationally expensive to execute, and vice versa.

In some embodiments, the constraint on the relative output quality degradation can be a largest acceptable relative output quality degradation, such as a largest percentage relative quality degradation, that the relative output quality degradations 610 for a machine learning model 150 need to be below in order to select that machine learning model 150 for use. In some embodiments, the constraint on the relative output quality degradation can be a quality constraints required to satisfy a service-level objective (SLO). In some other embodiments, rather than requiring that the relative output quality degradation predicted from each of the metric values satisfy a constraint for a machine learning model 150, the routing application 146 could employ a more permissive rule, such as requiring the relative output quality degradation predicted from any of the metric values to satisfy a constraint for a machine learning model 150, requiring an average (e.g., a weighted average) of the relative output quality degradation predicted from the metric values to satisfy a constraint for a machine learning model 150, or the like. It should be noted that the more restrictive rule of requiring the relative output quality degradation predicted from each of the metric values to satisfy a constraint errs on the side of generating higher quality outputs, whereas more permissive rules would allow lower quality outputs in order to improve performance/reduce computational expense.

More formally, the derivation of Θ, described above in conjunction with FIG. 4, allows the objective function of routing to be defined as follows.

$${m}_{opt} ( {ϵ}^{′} ) = {arg max}_{m s . t . Θ ( m , q ) > {ϵ}^{′}} P ( m , q ) . \qquad ( 4 )$$

In the worst case, equation (4) invokes m′ (q) (the biggest/slowest model). As described above in conjunction with FIG. 4, candidate metrics c can be used to compute corresponding Θ estimators. Using an ensemble of Θ estimators, as shown in equation (5) can mitigate the risk of an inaccurate routing decision.

$${m}_{opt} ( {ϵ}^{′} ) = {arg max}_{m s . t . {Θ}_{1} ( m , q ) > {ϵ}^{′} ∀ {Θ}_{ι} ∈ \{ {Θ}_{0} , {Θ}_{1} … \}} P ( m , q ) . \qquad ( 5 )$$

When each Θ-function is computationally light, computing multiple Θ-functions together should still not induce significant overheads. To solve equation (5), the arg max function needs to be computed, which requires iterating over the model list M. In some embodiments, the models can be sorted in order of size (which serves as a proxy for P (m, q)). For each model, Θ (m, q) is computed. If the constraints are satisfied, m (q) is computed and the output returned. The most computationally expensive model (e.g., a largest model) will yield 100% quality for every Θ function, since the degradation estimate is computed in relation to such a model. The user-defined e′ threshold is constrained so that the threshold cannot exceed 100%; thus, some viable candidate model is guaranteed to be found to serve an input.

Algorithm 1 presents the routing technique used by the routing application 146 in pseudocode. In effect, Algorithm 1 iteratively computes and moves along the Θ-approximated Pareto-frontier between performance and quality for a given input and metric. Algorithm 1 then returns the point along the frontier that satisfies the quality requirement across all metrics.

```
Algorithm 1 Θ - Proxy Routing Procedure
for m ∈ M do
  for Θ ∈ Θ₀, Θ₁, ... do
    if Θ(m, q) < ϵ′ then
      skip to next m
    end if
  end for
  return m, m(q)
end for
```

FIG. 7 illustrates a flow diagram of method steps for determining the relative output quality degradations of the different machine learning models included in a set of machine learning models, according to various embodiments. Although the method steps are described in conjunction with the systems of FIGS. 1-4 and 6, persons of ordinary skill in the art will understand that any system configured to perform the method steps, in any order, is within the scope of the inventions.

As shown, a method 700 begins at step 702, where the relative degradation application 116 receives example inputs. At step 704, the relative degradation application 116 selects one of the example inputs for processing.

At step 706, the relative degradation application 116 computes one or more metric values based on the selected example input. Any technically feasible metrics can be used in some embodiments. For example, in some embodiments, the metrics can include a length of the selected example input, a number of nouns in the selected example input, and/or a reading time associated with the selected example input.

At step 708, the relative degradation application 116 processes the selected example input using a set of machine learning models to generate outputs. The set of machine learning models can include some machine learning models that are more computationally expensive and/or consume more energy to execute than some other machine learning models.

At step 710, the relative degradation application 116 computes a quality of each of the outputs generated by the machine learning models. Any technically feasible quality metric can be used in some embodiments. For example, in some embodiments, the quality metric can be a score generated for each output by a chatbot that is asked to assess the quality of the output. As another example, in some embodiments, the quality metric can be a measure of accuracy of the output.

At step 712, the relative degradation application 116 computes a relative quality degradation between the output of a most computationally expensive machine learning model and the output of each other machine learning models in the set of machine learning models. The relative output quality degradation is a difference in quality of the output from a machine learning model in the set of machine learning models compared to an output from the most computationally expensive machine learning model in the set of machine learning models. Returning to the example of scores generated by a chatbot, the relative output quality degradation can be a chatbot-assessed loss that is the difference between the score for an output of the most computationally expensive machine learning model and the score for another machine learning model in the set of machine learning models. The output quality degradation can be represented in any technically feasible manner, such as using a value between 0% and 100% to indicate the percent degradation.

At step 714, if there are more example inputs, then the method 700 returns to step 704, where the relative degradation application 116 selects another one of the example inputs for processing.

On the other hand, if there are no more example inputs, then the method 700 continues to step 716, where the relative degradation application 116 stores an association between buckets of the computed metric values and the computed relative output quality degradations. The computed metric values can be grouped into any suitable buckets, such as quantile buckets, in some embodiments. In some other embodiments, metric values can be associated with relative output quality degradations in any technically feasible manner, such as by fitting a function to a curve formed by the metric values on one axis and the relative output quality degradations on another axis.

FIG. 8 illustrates a flow diagram of method steps for routing an input for execution by a given machine learning model included in a set of machine learning models based on relative output quality degradation, according to various embodiments. Although the method steps are described in conjunction with the systems of FIGS. 1-4 and 6, persons of ordinary skill in the art will understand that any system configured to perform the method steps, in any order, is within the scope of the inventions.

As shown, a method 800 begins at step 802, where the routing application 146 receives an input. Any suitable input, such as user input entered via a UI, can be received in some embodiments.

At step 804, the routing application 146 computes a metric value based on the input. The value of any technically feasible metric can be computed in some embodiments. In some embodiments, the same metric(s) can be used that were used in the method 700, described above in conjunction with FIG. 7, to associate metric values with relative output quality degradations of a set of machine learning models. In some embodiments, the metric(s) can include domain-specific complexity measures. In some embodiments, the metric(s) can include lexical analysis techniques. For example, in some embodiments, the metric(s) can include a length of the selected example input, a number of nouns in the selected example input, and/or a reading time associated with the selected example input.

At step 806, the routing application 146 determines a bucket to which the computed metric value computed at step 804 belongs. The computed metric value can be assigned to any suitable buckets, such as quantile buckets, in some embodiments. In some embodiments, the same buckets can be used that were used in the method 700, described above in conjunction with FIG. 7, to associate metric values with relative output quality degradations of a set of machine learning models.

At step 808, the routing application 146 determines a relative output quality degradation associated with the bucket for each machine learning model in a set of machine learning models. In some embodiments, the routing application 146 can look up the relative output quality degradation associated with the bucket for each machine learning model, as determined and stored according to the method 700, described above in conjunction with FIG. 7.

At step 810, if there are more metrics, then the method 800 returns to step 804, where the routing application 146 computes the value of another metric based on the input. Although described with respect to steps 804, 806, and 808 being performed serially for different metrics, in some embodiments, steps 804, 806, and 808 can be performed in parallel for multiple metrics.

On the other hand, if there are no more metrics, then the method 800 continues to step 812, where the routing application 146 selects, for each of the machine learning models, a largest relative output quality degradation from the relative output quality degradations determined for different metrics at step 808.

At step 814, the routing application 146 determines a least computationally expensive machine learning model in the set of machine learning models that satisfies a constraint on the relative output quality degradation for each of the metrics that a value was computed at step 804. Any suitable constraint can be used in some embodiments, such as a threshold that the relative output quality degradation cannot drop below, a constraint required to satisfy a SLO, and/or the like. In some other embodiments, rather than requiring that the relative output quality degradation predicted from each of the metric values to satisfy a constraint, the routing application 146 could employ a more permissive rule, such as requiring the relative output quality degradation predicted from any of the metric values to satisfy a constraint, requiring an average (e.g., a weighted average) of the relative output quality degradation predicted from the metric values to satisfy a constraint, or the like.

At step 816, the routing application 146 routes the input for processing by the least computationally expensive machine learning model. The least computationally expensive machine learning model then generates an output that can be returned to a user, such as by displaying the output via a display device, or otherwise used by the routing application 146 or another application.

In sum, techniques are disclosed for routing inputs over machine learning models for processing. In some embodiments, a relative degradation application receives example inputs and computes one or more metric values for the example inputs. The relative degradation application determines, for each of the example inputs, a relative degradation between the quality of the output of each machine learning model in a set of machine learning models and the output of a most computationally expensive machine learning model in the set of machine learning models. Associations between the metric value(s) and the relative output quality degradations of the machine learning models are stored. Given an input, a routing application computes the same metric value(s) for the input and selects, based on the associations between metric value(s) and relative output quality degradations of the machine learning models, a least computationally expensive machine learning model from the set of machine learning models that is associated with a relative output quality degradation that satisfies a predefined constraint. Then, the application processes the input using the selected machine learning model to generate an output.

At least one technical advantage of the disclosed techniques relative to the prior art is that the disclosed techniques robustly and reliably balance the tradeoff between the size of a machine learning model and the accuracy of a machine learning model in a way that can be implemented for many, if not all, machine learning model applications. In this regard, the disclosed techniques route inputs to a first machine learning model within a set of machine learning models for execution, where the first machine learning model is the least computationally expensive machine learning model within the set of machine learning models having a predicted output quality degradation relative to the output quality of the most computationally expensive machine learning within the set of machine learning models that satisfies a desired constraint. By using the least computationally expensive machine learning model, while maintaining a desired level of output quality, the disclosed techniques can save computational resources, computational time, and energy. In addition, the predicted relative output quality degradation between the least expensive machine learning model and the most computationally expensive machine learning model within the set of machine learning models can be computed in an efficient manner using relatively simple metrics, including metrics specific to particular domains, while still being able to predict the relative output accuracy for different types of inputs that can be processed using the set of machine learning models. These technical advantages represent one or more technological improvements over prior art approaches.

1. In some embodiments, a computer-implemented method for routing inputs to machine learning models for execution comprises computing one or more metric values based on an input, determining, for at least one trained machine learning model included in a plurality of trained machine learning models, a corresponding output quality degradation based on the one or more metric values, wherein the corresponding output quality degradation is relative to a most computationally expensive trained machine learning model included in the plurality of trained machine learning models, selecting a first trained machine learning model included in the plurality of trained machine learning models based on the corresponding output quality degradations, and transmitting the input to the first trained machine learning model for execution.

2. The computer-implemented method of clause 1, wherein determining, for the at least one trained machine learning model included in the plurality of machine learning models, a corresponding output quality degradation comprises, for each trained machine learning model included in the at least one trained machine learning model for each metric value included in the one or more metric values, determining a corresponding intermediate output quality degradation, and selecting a largest output quality degradation from the corresponding intermediate output quality degradations as the corresponding output quality degradation.

3. The computer-implemented method of clauses 1 or 2, wherein for each metric value included in the one or more metric values, determining a corresponding intermediate output quality degradation comprises determining a bucket included in a plurality of buckets to which the metric value belongs, and determining the corresponding intermediate output quality degradation based on the bucket.

4. The computer-implemented method of any of clauses 1-3, wherein the first trained machine learning model comprises a least computationally expensive trained machine learning model included in the plurality of machine learning models having a corresponding output quality degradation that satisfies a predefined condition.

5. The computer-implemented method of any of clauses 1-4, wherein the one or more metric values include a count of a number of words included in the input.

6. The computer-implemented method of any of clauses 1-5, wherein the one or more metric values include a count of a number of nouns included in the input.

7. The computer-implemented method of any of clauses 1-6, wherein the one or more metric values include a reading time duration associated with the input.

8. The computer-implemented method of any of clauses 1-7, wherein each trained machine learning model included in the plurality of trained machine learning models comprises a language model.

9. The computer-implemented method of any of clauses 1-8, further comprising computing a plurality of additional metric values based on a plurality of example inputs, determining, for each trained machine learning model included in the one or more trained machine learning models, an additional corresponding output quality degradation for each example input included in the plurality of example inputs, and storing one or more associations between the plurality of additional metric values and the additional corresponding output quality degradations.

10. The computer-implemented method of any of clauses 1-9, wherein determining, for each trained machine learning model included in the one or more trained machine learning models, an additional corresponding output quality degradation for each example input comprises computing a difference between an accuracy of the trained machine learning model for the example input and an accuracy of the most computationally expensive trained machine learning model included in the plurality of trained machine learning models for the example input.

11. In some embodiments, one or more non-transitory computer-readable media store instructions that, when executed by at least one processor, cause the at least one processor to perform steps comprising computing one or more metric values based on an input, determining, for at least one trained machine learning model included in a plurality of trained machine learning models, a corresponding output quality degradation based on the one or more metric values, wherein the corresponding output quality degradation is relative to a most computationally expensive trained machine learning model included in the plurality of trained machine learning models, selecting a first trained machine learning model included in the plurality of trained machine learning models based on the corresponding output quality degradations, and transmitting the input to the first trained machine learning model for execution.

12. The one or more non-transitory computer-readable media of clause 11, wherein determining, for one or more trained machine learning models included in the plurality of machine learning models, a corresponding output quality degradation comprises, for each trained machine learning model included in the one or more trained machine learning models for each metric value included in the one or more metric values, determining a corresponding intermediate output quality degradation, and selecting a largest output quality degradation from the corresponding intermediate output quality degradations as the corresponding output quality degradation.

13. The one or more non-transitory computer-readable media of clauses 11 or 12, wherein for each metric value included in the one or more metric values, determining a corresponding intermediate degradation comprises determining a bucket included in a plurality of buckets to which the metric value belongs, and determining the corresponding intermediate output quality degradation based on the bucket.

14. The one or more non-transitory computer-readable media of any of clauses 11-13, wherein the plurality of buckets include a plurality of quantile buckets.

15. The one or more non-transitory computer-readable media of any of clauses 11-14 wherein the first trained machine learning model comprises a least computationally expensive trained machine learning model included in the plurality of machine learning models having a corresponding output quality degradation that satisfies a predefined condition.

16. The one or more non-transitory computer-readable media of any of clauses 11-15, wherein the one or more metric values include at least one of a count of a number of words included in the input, a count of a number of nouns included in the input, or a reading time duration associated with the input.

17. The one or more non-transitory computer-readable media of any of clauses 11-16, wherein each trained machine learning model included in the plurality of trained machine learning models comprises a language model.

18. The one or more non-transitory computer-readable media of any of clauses 11-17, wherein the instructions, when executed by the at least one processor, further cause the at least one processor to perform the steps of computing a plurality of additional metric values based on a plurality of example inputs, determining, for each trained machine learning model included in the one or more trained machine learning models, an additional corresponding output quality degradation for each example input included in the plurality of example inputs, and storing one or more associations between the plurality of additional metric values and the additional corresponding output quality degradations.

19. The one or more non-transitory computer-readable media of any of clauses 11-18, wherein determining the one or more associations comprises determining, for each additional metric value included in the plurality of additional metric values, a bucket included in a plurality of buckets that the additional metric value belongs to, and storing an association between each bucket included in the plurality of buckets and an average of the additional corresponding output quality degradations that are determined for example inputs whose additional metric values belong to the bucket.

20. In some embodiments, a system comprises one or more memories storing instructions, and one or more processors coupled to the one or more memories that, when executing the instructions, perform the steps of computing one or more metric values based on an input, determining, for at least one trained machine learning models included in a plurality of trained machine learning models, a corresponding output quality degradation based on the one or more metric values, wherein the corresponding output quality degradation is relative to a most computationally expensive trained machine learning model included in the plurality of trained machine learning models, selecting a first trained machine learning model included in the plurality of trained machine learning models based on the corresponding output quality degradations, and transmitting the input to the first trained machine learning model for execution.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general-purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for routing inputs to machine learning models for execution, the method comprising:
computing one or more metric values based on an input;
determining, for at least one trained machine learning model included in a plurality of trained machine learning models, a corresponding output quality degradation based on the one or more metric values, wherein the corresponding output quality degradation is relative to a most computationally expensive trained machine learning model included in the plurality of trained machine learning models;
selecting a first trained machine learning model included in the plurality of trained machine learning models based on the corresponding output quality degradations; and
transmitting the input to the first trained machine learning model for execution.

2. The computer-implemented method of claim 1, wherein determining, for the at least one trained machine learning model included in the plurality of machine learning models, a corresponding output quality degradation comprises, for each trained machine learning model included in the at least one trained machine learning model:
for each metric value included in the one or more metric values, determining a corresponding intermediate output quality degradation; and
selecting a largest output quality degradation from the corresponding intermediate output quality degradations as the corresponding output quality degradation.

3. The computer-implemented method of claim 2, wherein for each metric value included in the one or more metric values, determining a corresponding intermediate output quality degradation comprises:
determining a bucket included in a plurality of buckets to which the metric value belongs; and
determining the corresponding intermediate output quality degradation based on the bucket.

4. The computer-implemented method of claim 1, wherein the first trained machine learning model comprises a least computationally expensive trained machine learning model included in the plurality of machine learning models having a corresponding output quality degradation that satisfies a predefined condition.

5. The computer-implemented method of claim 1, wherein the one or more metric values include a count of a number of words included in the input.

6. The computer-implemented method of claim 1, wherein the one or more metric values include a count of a number of nouns included in the input.

7. The computer-implemented method of claim 1, wherein the one or more metric values include a reading time duration associated with the input.

8. The computer-implemented method of claim 1, wherein each trained machine learning model included in the plurality of trained machine learning models comprises a language model.

9. The computer-implemented method of claim 1, further comprising:
computing a plurality of additional metric values based on a plurality of example inputs;
determining, for each trained machine learning model included in the one or more trained machine learning models, an additional corresponding output quality degradation for each example input included in the plurality of example inputs; and
storing one or more associations between the plurality of additional metric values and the additional corresponding output quality degradations.

10. The computer-implemented method of claim 9, wherein determining, for each trained machine learning model included in the one or more trained machine learning models, an additional corresponding output quality degradation for each example input comprises computing a difference between an accuracy of the trained machine learning model for the example input and an accuracy of the most computationally expensive trained machine learning model included in the plurality of trained machine learning models for the example input.

11. One or more non-transitory computer-readable media storing instructions that, when executed by at least one processor, cause the at least one processor to perform steps comprising:
computing one or more metric values based on an input;
determining, for at least one trained machine learning model included in a plurality of trained machine learning models, a corresponding output quality degradation based on the one or more metric values, wherein the corresponding output quality degradation is relative to a most computationally expensive trained machine learning model included in the plurality of trained machine learning models;
selecting a first trained machine learning model included in the plurality of trained machine learning models based on the corresponding output quality degradations; and
transmitting the input to the first trained machine learning model for execution.

12. The one or more non-transitory computer-readable media of claim 11, wherein determining, for one or more trained machine learning models included in the plurality of machine learning models, a corresponding output quality degradation comprises, for each trained machine learning model included in the one or more trained machine learning models:
for each metric value included in the one or more metric values, determining a corresponding intermediate output quality degradation; and
selecting a largest output quality degradation from the corresponding intermediate output quality degradations as the corresponding output quality degradation.

13. The one or more non-transitory computer-readable media of claim 12, wherein for each metric value included in the one or more metric values, determining a corresponding intermediate degradation comprises:
determining a bucket included in a plurality of buckets to which the metric value belongs; and
determining the corresponding intermediate output quality degradation based on the bucket.

14. The one or more non-transitory computer-readable media of claim 13, wherein the plurality of buckets include a plurality of quantile buckets.

15. The one or more non-transitory computer-readable media of claim 11 wherein the first trained machine learning model comprises a least computationally expensive trained machine learning model included in the plurality of machine learning models having a corresponding output quality degradation that satisfies a predefined condition.

16. The one or more non-transitory computer-readable media of claim 11, wherein the one or more metric values include at least one of a count of a number of words included in the input, a count of a number of nouns included in the input, or a reading time duration associated with the input.

17. The one or more non-transitory computer-readable media of claim 11, wherein each trained machine learning model included in the plurality of trained machine learning models comprises a language model.

18. The one or more non-transitory computer-readable media of claim 11, wherein the instructions, when executed by the at least one processor, further cause the at least one processor to perform the steps of:
computing a plurality of additional metric values based on a plurality of example inputs;
determining, for each trained machine learning model included in the one or more trained machine learning models, an additional corresponding output quality degradation for each example input included in the plurality of example inputs; and
storing one or more associations between the plurality of additional metric values and the additional corresponding output quality degradations.

19. The one or more non-transitory computer-readable media of claim 18, wherein determining the one or more associations comprises:
determining, for each additional metric value included in the plurality of additional metric values, a bucket included in a plurality of buckets that the additional metric value belongs to; and
storing an association between each bucket included in the plurality of buckets and an average of the additional corresponding output quality degradations that are determined for example inputs whose additional metric values belong to the bucket.

20. A system, comprising:
one or more memories storing instructions; and
one or more processors coupled to the one or more memories that, when executing the instructions, perform the steps of:
computing one or more metric values based on an input,
determining, for at least one trained machine learning models included in a plurality of trained machine learning models, a corresponding output quality degradation based on the one or more metric values, wherein the corresponding output quality degradation is relative to a most computationally expensive trained machine learning model included in the plurality of trained machine learning models,
selecting a first trained machine learning model included in the plurality of trained machine learning models based on the corresponding output quality degradations, and
transmitting the input to the first trained machine learning model for execution.
